(19) United States
(12) Patent Application Publication
(10) Pub. No.: US 2007/0200029 A1
(43) Pub. Date: Aug. 30, 2007

(54) Hydraulic cycloidal control system

(76) Inventor: Callum R. Sullivan, New Market, AL (US)

Correspondence Address: ATTN: NEIL K. NYDEGGER;NYDEGGER & ASSOCIATES, 348 Olive Street, San Diego, CA, 92103, US

(21) Appl. No.: 11/363,115

(22) Filed: Feb. 27, 2006

(51) Int. Cl. B64C 39/00

(52) U.S. Cl. 244/10

(57) ABSTRACT

A cycloidal propulsion unit for controlling a thrust vector includes a hub that rotates about a hub axis. Further, the unit includes an airfoil blade pivotally mounted on the hub along a blade axis parallel to the hub axis. As a result, the blade may pivot about the blade axis while traveling along a blade path during rotation of the hub. The unit further includes a ring that rotates around a ring axis parallel to the hub axis. The ring is interconnected with the blade via a control rod. Also, a device is engaged with the ring to selectively position the ring axis relative to the hub axis. As a result of these structures, selective positioning of the ring axis provides control of the rotation of the blade about the blade axis as the blade travels along the blade path.

The U.S. Government has a paid-up license in this invention and the right in limited circumstances to require the patent owner to license others on reasonable terms as provided for by the terms of Contract No. N68335-00-C-0201 awarded by NAVAIR.

### FIELD OF THE INVENTION

The present invention pertains generally to propulsion and flight control units. In particular, the present invention pertains to cycloidal propulsion and flight control units incorporating airfoil blades that are rotated to create a thrust vector. The present invention is particularly, but not exclusively, useful as a system and method for creating and controlling thrust vectors through hydraulic control of the orientation of the airfoil blades.

### BACKGROUND OF THE INVENTION

For atmospheric flight by heavier-than-air vehicles, it is well known that airfoils can be used in various ways to either propel or control the flight of the vehicle. For example, propellers are airfoils; the wings of airplanes are airfoils; and the rotor-blades of helicopters are airfoils. Broadly defined, an “airfoil” is a part or a surface, such as a wing, a propeller blade or rudder, whose shape and orientation control the stability, direction, lift, thrust, or propulsion of an aerial vehicle. For the purposes of the present invention, an airfoil is to be generally considered as an aerodynamically shaped, elongated blade that defines a longitudinal axis which extends from the root of the blade to its tip. The blade also defines a chord line that extends from the leading edge of the blade to its trailing edge, and that is generally perpendicular to the blade axis. As is well known, various configurations of airfoils have been designed and constructed for different kinds of aerial vehicles. The more commonly known vehicles that incorporate airfoils include: airplanes, helicopters, auto-gyros, rockets, and tilt-wing aircraft.

As early as the 1930s, there was some experimentation with cycloidal propellers. Specifically, these propellers each incorporate several blades which move on respective cycloidal-type paths as they rotate about a common axis. Cycloidal propellers have the common characteristic that the respective longitudinal axis of each blade remains substantially parallel to a common axis of rotation as the propeller is rotated. In another aspect, however, cycloidal propellers can be rotated in either of two modes. One mode (prolate) is characterized by a blade movement wherein the chord line of the blade remains substantially parallel to the flight path of the vehicle as the blade is rotated around the common axis. Another mode (curtate) is characterized by a blade movement wherein the chord line of the blade remains substantially tangential to the rotational path of the blade around the common axis. It is the curtate mode which is of interest herein.

In a propulsion unit using the curtate mode, the thrust vector of the unit can be manipulated by concertedly varying the orientations of all of the airfoil blades. In light of this fact, it is an object of the present invention to provide a system and method for controlling the orientation of a single airfoil blade or a plurality of airfoil blades as it travels about its blade path. Another object of the present invention is to provide a system and method for creating and controlling the thrust vector of an aerial vehicle having a cycloidal propulsion unit. Yet another object of the present invention is to provide a system for moving an aerial vehicle which is simple to operate, relatively easy to manufacture, and comparatively cost effective.

### SUMMARY OF THE INVENTION

In accordance with the present invention, a cycloidal propulsion unit incorporates a system for controlling the propulsion unit's thrust vector. Structurally, the cycloidal propulsion unit comprises a base, such as the fuselage of an aerial vehicle, with a hub mounted thereon for rotation about a hub axis. Further, the unit includes a drive shaft or other means for rotating the hub about the hub axis.

For the present invention, at least one airfoil-shaped blade is mounted on the hub for travel thereon along a blade path around the hub axis. As the blade travels along the blade path, it can be manipulated to provide propulsion, as well as lift and control of the vehicle. Structurally, the blade defines a blade axis that is oriented substantially parallel to the hub axis and a chord line that extends from the blade's leading edge to its trailing edge. In the present invention, the blade is pivotally connected to the hub along the blade axis. As a result, the blade may pivot about the blade axis while it travels along the blade path around the hub axis.

Operationally, a control assembly pivots each blade about the respective blade axis to control the blade's angle of attack (i.e. the angle between the chord line of the blade and the relative wind). For the present invention, the control assembly includes a ring mounted on the base for rotation around a ring axis that is substantially parallel to the hub axis. Further, the control unit includes a control rod having an end that is affixed to a point on the ring, and an end that is pivotally attached to a point on the blade. In addition to the ring and control rod, the control unit includes a positioning device that is mounted on the base and engages the ring to selectively position the ring axis relative to the hub axis. As a result of movement of the ring axis relative to the hub axis, the control rod pivots the blade about the blade axis as the airfoil blade travels along the blade path. In this manner, a thrust vector for the propulsion unit is created and controlled.

Structurally, the positioning device includes two substantially perpendicular adjusters that are mounted on the base. Preferably, each adjuster comprises two collinear hydraulic pistons that are positioned around, and oriented for reciprocal radial movement relative to, the hub axis. Further, the positioning device includes a roller mounted at the outer end of each piston to engage the ring. As a result of this cooperation of structure, the ring is able to rotate around the positioning device. For the purposes of the present invention, a hydraulic device is connected to the pistons to selectively extend and retract the pistons to selectively position the ring axis relative to the hub axis. As a result of the movement of the ring axis, each control rod pivots a respective airfoil blade about its blade axis as the airfoil blade travels along the blade path. In this manner, a thrust vector for the propulsion unit is created and controlled.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an aerial vehicle employing the cycloidal propulsion system of the present invention;

FIG. 2 is a cross-sectional view of an airfoil (blade) of the cycloidal propulsion system of the present invention as seen along the line 2-2 in FIG. 1, with representative aerodynamic forces acting on the airfoil superposed thereon;

FIG. 3A is a schematic view of the airfoils (blades) of the cycloidal propulsion system in a first orientation;

FIG. 3B is a schematic view of the airfoils (blades) of the cycloidal propulsion system in a second orientation;

FIG. 4A is a schematic view of the positioning assembly in the orientation shown in FIG. 3A; and

FIG. 4B is a schematic view of the positioning assembly in the orientation shown in FIG. 3B.

### DESCRIPTION OF THE PREFERRED EMBODIMENTS

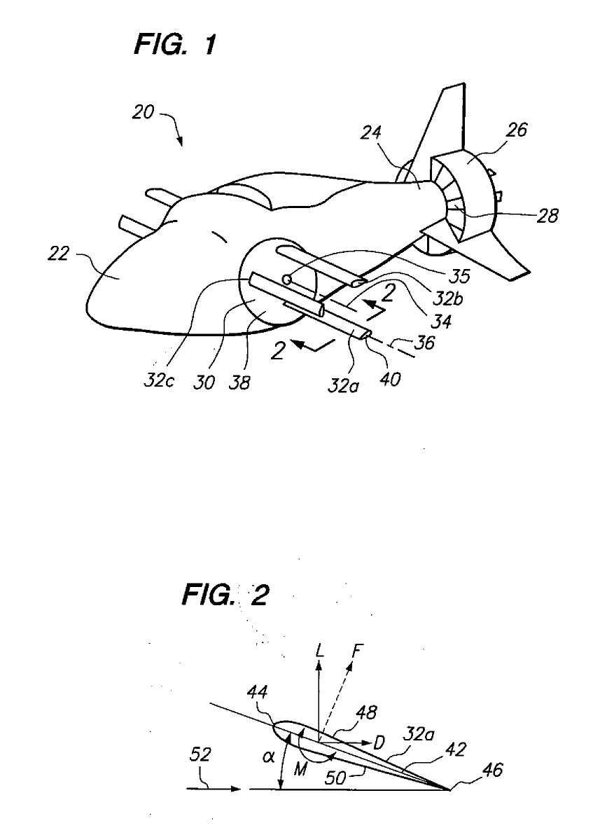

Referring initially to FIG. 1, an aerial vehicle that incorporates a cycloidal propulsion and control system in accordance with the present invention is shown and is generally designated 20. As shown, the vehicle 20 has a fuselage 22 and an empennage 24. A shroud 26 is shown mounted on the empennage 24 and a propeller 28 is surrounded by the shroud 26. From FIG. 1 it will be appreciated there is a hub assembly on each side of the fuselage 22 that includes a hub 30 and a plurality of blades 32. As shown, the hub 30 is centered about a hub axis 34 and can be rotated by a drive shaft 35 operated by the vehicle 20. As intended for the present invention, the plurality of blades 32 can be rotated with the hub 30 around the hub axis 34. At this point, it is to be noted that for purposes of this disclosure, the blades 32a, 32b and 32c shown in FIG. 1 are only exemplary because there may be either more or fewer blades 32 used in a hub assembly. Accordingly, discussions herein are often made with reference to only a single blade 32. With this in mind, the referenced blade 32 may, in fact, be any one of the blades 32a, 32b or 32c. In any event, each blade 32 is an airfoil.

As indicated in FIG. 1, each blade 32 (e.g. blade 32a) has a blade axis 36 that extends generally in a direction from the root 38 of the blade 32 to its tip 40. Using this structure as a base for reference, the aerodynamic properties of the blade 32 will be better appreciated with reference to FIG. 2. There it will be seen that each blade 32 defines a chord line 42 that extends from the leading edge 44 of the blade 32 to its trailing edge 46, and that is generally perpendicular to the blade axis 36. Depending on several factors, which include the respective design shapes of the upper surface 48 and the lower surface 50 of the blade 32, as well as the angle of attack (a) between the chord line 42 and the relative wind 52, an aerodynamic force (F) will be generated on the blade 32 in accordance with well known aerodynamic principles. Specifically, as shown in FIG. 2, components of the force (F) will include lift (L) and drag (D), as well as a moment (M). For purposes of this disclosure, it is sufficient to appreciate that these forces are generated on the blade 32 in response to a relative wind 52, and that these forces can be controlled by properly orienting the blade 32 with the relative wind 52.

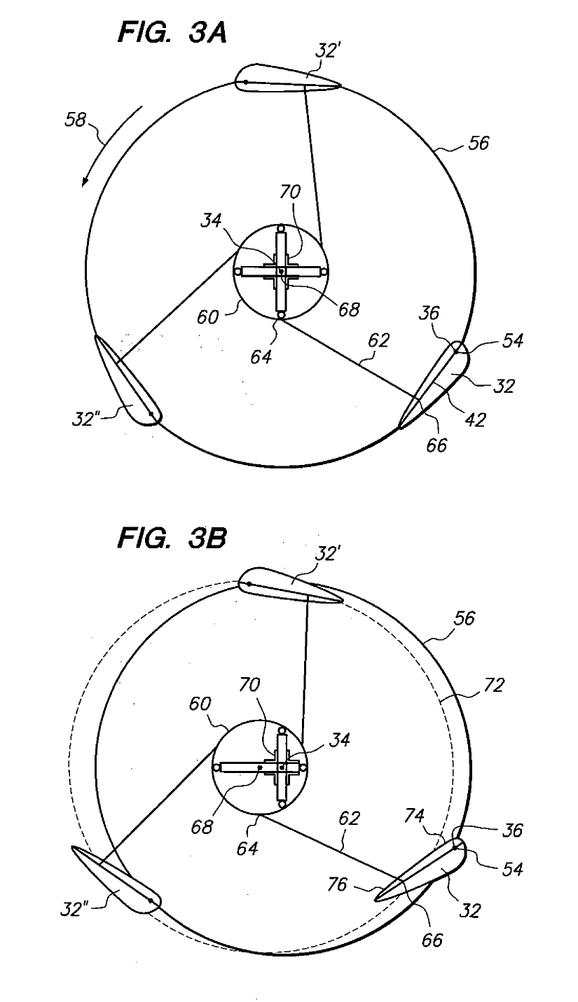

As mentioned above, the present invention envisions that the blades 32 will be rotated by the hub 30. As shown in FIG. 3A, to provide rotation to the blades 32, each blade 32 is fixed to the hub 30 at a pivot 54 on the blade axis 36. It will be appreciated that as the hub 30 rotates, each blade 32 will travel on a circular blade path 56 around the hub axis 34. When rotated in the direction of arrow 58, the blade 32 will sequentially pass through the locations on blade path 56 indicated by blade 32, 32′ and 32″, which are indicative of cycloidal systems that operate in the curtate mode.

As shown in FIG. 3A, each blade 32 is further connected to a ring 60 by a control rod 62. Specifically, an end 64 of each control rod 62 is pivotally mounted to the ring 60 while the opposite end 66 is connected to a blade 32. With this cooperation of structure, rotation of the hub 30 is communicated to, and causes the rotation of, the ring 60. In the orientation shown, the ring 60 rotates about a ring axis 68 that is collinear with the hub axis 34. When the ring axis 68 and hub axis 34 are collinear, the chord line 42 of each blade 32 remains substantially tangential to the blade path 56 as the blades 32 travel along the blade path 56.

For the present invention, the position of the ring axis 68 relative to the hub axis 34 may be manipulated. Specifically, a positioning system 70 is provided to move the ring 60 so that the ring axis 68 is spaced from and parallel to the hub axis 34. Cross-referencing FIG. 3A with FIG. 3B, the effect of the positioning system 70 may be understood. As seen in FIG. 3B, the positioning system 70 has moved the ring 60 laterally so that the ring axis 68 is spaced from the hub axis 34. As a result, the control rods 62 have forced each blade 32 to pivot about its blade axis 36. As shown by the dashed line representing the trailing path 72 of each pivot 54, each blade 32 will pivot about its blade axis 36 as it rotates with the hub 30, with its leading end 74 traveling along the blade path 56 and its trailing end 76 traveling along the trailing path 72. In this manner, the blade 32 will sequentially pass through the orientations on the blade path 56 and trailing path 72 indicated by blade 32, 32′, and 32″ in FIG. 3B. As a result, the respective angles of attack (a) for the airfoil blades 32 in the curtate flight mode is accomplished by collectively pivoting the blades 32 by controlling the position of the ring 60 relative to the hub 30. In this manner, a desired aerodynamic force can be obtained and controlled for the aerial vehicle 20.

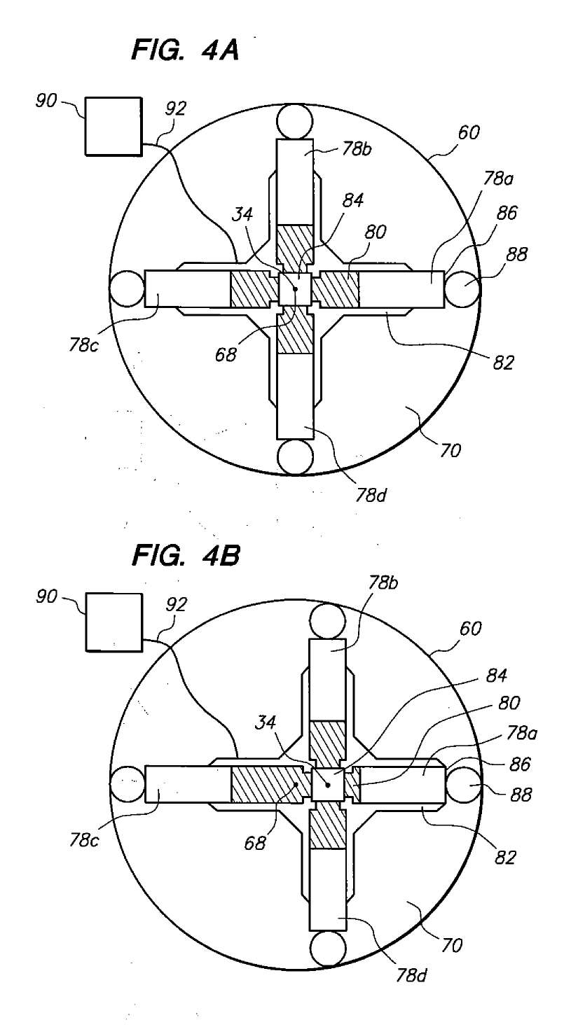

Referring now to FIG. 4A, the structure of the positioning system 70 of the present invention may be understood. As shown, the positioning system 70 includes four hydraulic pistons 78 (individually identified as 78a, 78b, 78c and 78d). Each piston 78 is received in a chamber 80 formed by a housing 82. For the purposes of the present invention, the chambers 80 extend radially outward from a stationary base 84 to allow the pistons 78 to retract toward and extend away from the base 84. As shown, each piston 78 has a radially distal end 86 that is connected to a roller 88. Each roller 88 engages the ring 60 and allows it to rotate about the ring axis 68 (which, in FIG. 4A, is shown as being collinear with the hub axis 34). As a result of this cooperation of structure, coordinated extension and retraction of the pistons 78 results in the movement of the ring 60 and ring axis 68. Such coordinated extension and retraction is controlled by a hydraulic device 90 which regulates the flow of fluid into and out of the chambers 80 through ducts 92 in order to selectively extend or retract each piston 78.

Cross-referencing FIG. 4A with FIG. 4B may facilitate the understanding of such coordinated extension and retraction. As shown, the piston 78a has been retracted into its chamber 80, while piston 78c has extended out of its chamber 80. At the same time, pistons 78b and 78d have retracted slightly into their respective chambers 80. As shown in FIG. 4B, the rollers 88 remain engaged with the ring 60 to allow it to rotate about the ring axis 68. As a result of this coordinated piston extension and retraction, the ring 60 has been moved laterally such that the ring axis 68 is no longer collinear with the hub axis 34 as it was in FIG. 4A. As can be understood from FIGS. 4A and 4B, the positioning system 70 of the present invention is able to selectively move the ring 60 and ring axis 68 to a wide range of positions through hydraulic control of the pistons 78 so that a thrust vector for the aerial vehicle 20 can be manipulated and controlled.

While the particular Hydraulic Cycloidal Control System as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A cycloidal propulsion unit which comprises:
a base;
a hub mounted on said base for rotation thereon about a central hub axis;
an airfoil-shaped blade defining a blade axis, said airfoil blade being mounted on said hub for travel thereon along a blade path around the hub axis, with the blade axis oriented substantially parallel to the hub axis for rotation of said airfoil blade about the blade axis;
a ring mounted on said base for rotation around a ring axis, wherein the ring axis is substantially parallel to the hub axis;
a control rod having a first end and a second end, wherein the first end of said control rod is affixed to a point on said ring, and the second end of said control rod is pivotally attached to a point on the airfoil blade;
a means for rotating said hub; and
a positioning device mounted on said base and engaged with said ring to selectively position the ring axis relative to the hub axis for moving said control rod with the ring to cyclically rotate said airfoil blade about the blade axis, as said airfoil blade travels along the blade path, to create and control a thrust vector for said propulsion unit.

2. A cycloidal propulsion unit as recited in claim 1 wherein said positioning device comprises:
a first adjuster mounted on said base, wherein said first adjuster has a first end and a second end;
a second adjuster mounted on said base, wherein said second adjuster has a first end and a second end, and wherein said second adjuster is substantially perpendicular to said first adjuster; and
a hydraulic means for moving the first and second ends of said first adjuster in concert with the first and second ends of said second adjuster to selectively position the ring axis relative to the hub axis.

3. A cycloidal propulsion unit as recited in claim 2 wherein each adjuster respectively comprises:
a first hydraulic piston oriented for reciprocal radial movement relative to the hub axis; and
a second hydraulic piston oriented collinear with said first hydraulic piston and diametrically opposite thereto for reciprocal radial movement relative to the hub axis.

4. A cycloidal propulsion unit as recited in claim 3 wherein each adjuster comprises a roller mounted on said first hydraulic piston and a roller mounted on said second hydraulic piston, with each roller engaged with said ring for movement of said ring about the ring axis.

5. A cycloidal propulsion unit as recited in claim 4 further comprising a hydraulic means in fluid communication with each said adjuster for moving said hydraulic pistons to selectively position the ring axis relative to the hub axis.

6. A cycloidal propulsion unit as recited in claim 1 further comprising:
a plurality of said airfoil blades; and
a plurality of control rods, wherein each control rod is attached to a respective airfoil blade.

7. A cycloidal propulsion unit as recited in claim 1 wherein said base is an aerial vehicle.

8. A control system for a cycloidal propulsion unit which comprises:
a base;
a first adjuster mounted on said base, wherein said first adjuster has a first end and a second end;
a second adjuster mounted on said base, wherein said second adjuster has a first end and a second end, and wherein said second adjuster is substantially perpendicular to said first adjuster;
a ring engaged with the respective first and second ends of said first and second adjusters for rotation thereon about a ring axis, wherein the ring axis is substantially parallel to the hub axis;
a hub mounted on said base for rotation thereon about the hub axis;
an airfoil blade defining a blade axis, said airfoil blade being mounted on said hub for rotation thereon about the blade axis, and for travel thereof along a blade path around the hub axis, with the blade axis oriented substantially parallel to the central axis;
a control rod having a first end and a second end, wherein the first end of said control rod is affixed to a point on said ring, and the second end of said control rod is pivotally attached to a point on the airfoil blade; and
a hydraulic means for moving the first and second ends of said first adjuster in concert with the first and second ends of said second adjuster to selectively position the ring axis relative to the hub axis for moving said control rod with the ring to cyclically rotate said airfoil blade about the blade axis, as said airfoil blade travels along the blade path, to create and control a thrust vector for said propulsion unit.

9. A control system as recited in claim 8 wherein each adjuster respectively comprises:
a first hydraulic piston oriented for reciprocal radial movement relative to the hub axis; and
a second hydraulic piston oriented collinear with said first hydraulic piston and diametrically opposite thereto for reciprocal radial movement relative to the hub axis.

10. A control system as recited in claim 9 wherein each adjuster comprises a roller mounted on said first hydraulic piston and a roller mounted on said second hydraulic piston, with each roller engaged with said ring for movement of said ring about the ring axis.

11. A control system as recited in claim 9 wherein the hydraulic means is in fluid communication with each said adjuster for moving said hydraulic pistons to selectively position the ring axis relative to the hub axis.

12. A control system as recited in claim 8 further comprising:
a plurality of said airfoil blades; and
a plurality of control rods, wherein each control rod is attached to a respective airfoil blade.

13. A control system as recited in claim 8 wherein said base is an aerial vehicle.

14. A method of controlling the thrust vector of a cycloidal propulsion unit having: (a) a base; (b) a hub mounted on said base for rotation thereon about a central hub axis; (c) an airfoil-shaped blade defining a blade axis, said airfoil blade being mounted on said hub for travel thereon along a blade path around the hub axis, with the blade axis oriented substantially parallel to the hub axis for rotation of said airfoil blade about the blade axis; (d) a ring mounted on said base for rotation around a ring axis, wherein the ring axis is substantially parallel to the hub axis; and (e) a control rod having a first end and a second end, wherein the first end of said control rod is affixed to a point on said ring, and the second end of said control rod is pivotally attached to a point on the airfoil blade, the method comprising the steps of:
rotating the hub; and
selectively positioning the ring axis relative to the hub axis to move said control rod with the ring to cyclically rotate said airfoil blade about the blade axis, as said airfoil blade travels along the blade path, to create and control a thrust vector for said propulsion unit.

15. A method as recited in claim 14 wherein said cycloidal propulsion unit includes a positioning device for selectively positioning the ring axis relative to the hub axis, and wherein said positioning device includes: (a) a first adjuster mounted on said base, wherein said first adjuster has a first end and a second end; and (b) a second adjuster mounted on said base, wherein said second adjuster has a first end and a second end, and wherein said second adjuster is substantially perpendicular to said first adjuster; and wherein the selectively positioning step includes moving the first and second ends of said first adjuster in concert with the first and second ends of said second adjuster to selectively position the ring axis relative to the hub axis.

16. A method as recited in claim 15 wherein said selectively positioning step comprises moving the first and second ends of said first adjuster and the first and second ends of said second adjuster hydraulically.

17. A method as recited in claim 16 wherein each adjuster respectively includes: (a) a first hydraulic piston oriented for reciprocal radial movement relative to the hub axis; and (b) a second hydraulic piston oriented collinear with said first hydraulic piston and diametrically opposite thereto for reciprocal radial movement relative to the hub axis, and wherein said selectively positioning step comprises operating each said first hydraulic piston and each said second hydraulic piston to move the first and second ends of said first adjuster and said second adjuster.

18. A method as recited in claim 14 wherein the cycloidal propulsion unit includes a plurality of said airfoil blades and a plurality of control rods, wherein each control rod is attached to a respective airfoil blade, and wherein the selectively positioning step moves each said control rod with the ring to cyclically rotate each said airfoil blade about the blade axis, as each said airfoil blade travels along the blade path, to create and control a thrust vector for said propulsion unit.
